(19) United States
(12) Patent Application Publication
(10) Pub. No.: US 2026/0252343 A1
(43) Pub. Date: Aug. 27, 2026

(54) INTERPROCESS COMMUNICATION FOR APPLICATION SOFTWARE DEVELOPMENT AND CONFIGURATION

(71) Applicant: PHUNWARE, INC., Austin, TX (US)

(72) Inventors: Andrew Soltan, Orange, CA (US); Dustin Tran, Rancho Santa Margarita, CA (US); Henry Peng, Diamond Bar, CA (US)

(21) Appl. No.: 19/060,740

(22) Filed: Feb. 23, 2025

(51) Int. Cl. G06F 8/71; G06F 8/65; G06F 9/54

(52) U.S. Cl. CPC G06F 8/71; G06F 8/65; G06F 9/547

(57) ABSTRACT

A method for interprocess communication for application software includes storing a Human Readable Data Structure (HRDS) on a server, automatically updating the stored HRDS in accordance with modification instructions and transmitting the stored HRDS to a smartphone having a touch screen capable of displaying a graphical user interface (GUI) as an interprocess communication, wherein the GUI of the smartphone is configured by the HRDS.

### BACKGROUND

Custom applications (“apps”) for mobile devices such as smartphones are highly desirable for many enterprises. For example, companies in the hospitality business use custom apps to attract and retain customers. A restaurant, hotel or resort may use a custom app to allow for reservations, provide information about services, provide contact information, provide navigation assistance, etc. Unfortunately, custom apps generally require significant investment of time and money to develop and test the apps, and to gain approval to include the app in an app store.

Even after the launch of a custom app there is the problem of providing updates. Just as with the original development of the app, updating an app is an expensive and time consuming process. To address this problem, some custom apps can be modified using configuration files that can be downloaded to the mobile devices running the custom apps. Unfortunately, developing configuration files are also significant time and cost burdens in that they tend to be manually developed by experienced app developers.

These and other limitations of the prior art will become apparent to those of skill in the art upon a reading of the following descriptions and a study of the several figures of the drawing.

### SUMMARY

An example interprocess communication system for application software includes an application program (app) including app code segments and a Human Readable Data Structure (HRDS) stored in a memory of a mobile device having a processor and a network interface, and a server including server code segments stored in a server memory, a processor, and a network interface. The app code segments include code segments communicating via the network interface of the mobile device, code segments downloading an automated HRDS update via the network interface of the mobile device and storing the automated HRDS update in the memory of the mobile device in an interprocess communication, and code segments configuring the app with the automated HRDS update. The server code segments include code segments communicating via the network interface of the server, code segments detecting an automated HRDS update trigger, code segments obtaining an HRDS to modify, and code segments modifying the HRDS in accordance with modification instructions to provide the automated HRDS update.

An example method for interprocess communication for application software includes storing a Human Readable Data Structure (HRDS) on a server, automatically updating the stored HRDS in accordance with modification instructions and transmitting the stored HRDS to a smartphone having a touch screen capable of displaying a graphical user interface (GUI) as an interprocess communication, wherein the GUI of the smartphone is configured by the HRDS.

These and other embodiments, features and advantages will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 is an example interprocess communication system for application software development and configuration;

FIG. 2 is a mobile device of the example system;

FIG. 3 is a block diagram of the circuitry of the mobile device of FIG. 2;

FIG. 4 is a block diagram of a computer/server of the example system;

FIGS. 5A, 5B and 5C are example data structures for a Human Readable Data Structure (HRDS);

FIG. 6 is a flow diagram of a process to run an app on a mobile device;

FIG. 7 is a flow diagram of an example process to initialize the app of FIG. 6;

FIG. 8 is a flow diagram of an example process running on the back end and web server 14 of FIG. 1;

FIG. 9 is a flow diagram of an example initialize server operation 108 of FIG. 8;

FIGS. 10 and 11 are illustrations of portions of a web interface;

FIG. 12 is a flow diagram of an example operation to obtain HRDS modification instructions and to modify HRDS data;

FIG. 13A is a flow diagram of an example algorithmic process to automatically generate a modified HRDS; and

FIG. 13B is a flow diagram of an example generative artificial intelligence (AI) process to automatically generate a modified HRDS.

### DETAILED DESCRIPTION OF EXAMPLE EMBODIMENTS

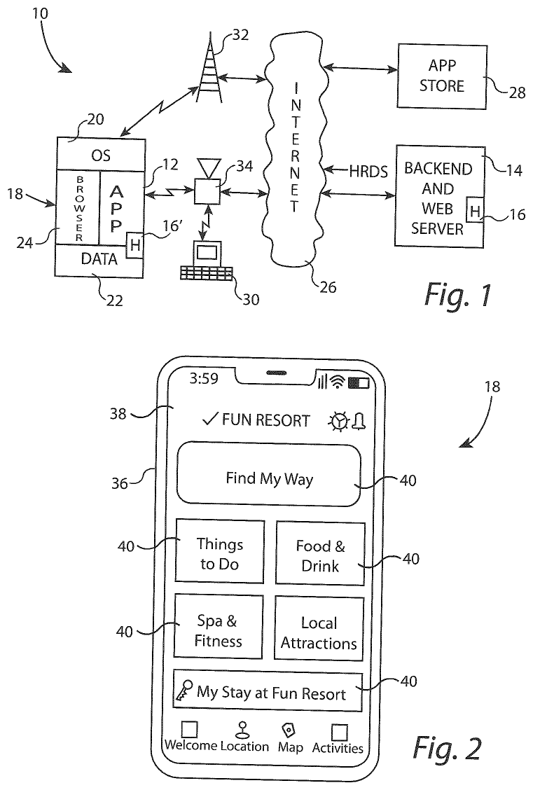

FIG. 1 is an interprocess communication system 10 for application software development and configuration including an application program (app) 12 and a back end and web server 14 storing a Human Readable Data Structure (HRDS) 16. The app 12 includes app code segments and a HRDS 16′ stored on a mobile device 18, which also includes an operating system (OS) 20, memory 22 for storing data and programs, and other apps such as a browser 24.

The HRDS 16 on the web server 14 is the most recent (“current”) version of the HRDS, and the HRDS 16′ on the mobile device may be the current version or an earlier version, including an initial version, depending upon internet availability. Both the server 14 and the mobile device 18 are provided with network interfaces which allow communication via the internet 26.

Also shown in FIG. 1 is an app store server 28, a personal computer 30, a cellular data tower 32, and a WiFi access point 34. The mobile device 18 can wirelessly communicate with cellular data tower 32 and WiFi access point 34 to access the internet 26 and the personal computer 30 can likewise wirelessly communicate with WiFi access point 34 to access the internet 26.

The servers 14 and 28 are also coupled to the internet through their respective network interfaces. The app store server 28 is typically maintained by a third party, such as Apple, and can be the source for the app 12, including an initial HRDS 16′ to be stored on mobile device 18.

The mobile device 18 is typically an internet-enabled cellular telephone and will be alternately referred to herein as a “smartphone.” Smartphones are manufactured by a variety of manufacturers such as Apple Inc. of Cupertino, California and Samsung Electronics Co., Ltd of South Korea. The OS 20 for Apple smartphones is iOS and the OS 20 for Samsung smartphones is One UI, which is an enhanced Android operating system. Alternatively, mobile device 18 can be a tablet computer or other mobile device using, for example, the iOS or Android operating system.

In FIG. 2, an example mobile device 18 includes a case 36 and a touchscreen 38. The touchscreen 38 is shown displaying home screen in the form of a graphical user interface (GUI) including a number of buttons 40 that can be touch-activated, as well as other icons, widgets, text labels and displays. As is well known to those skilled in the art, a widget on a smartphone is a small application program that displays information or performs a function on the home screen.

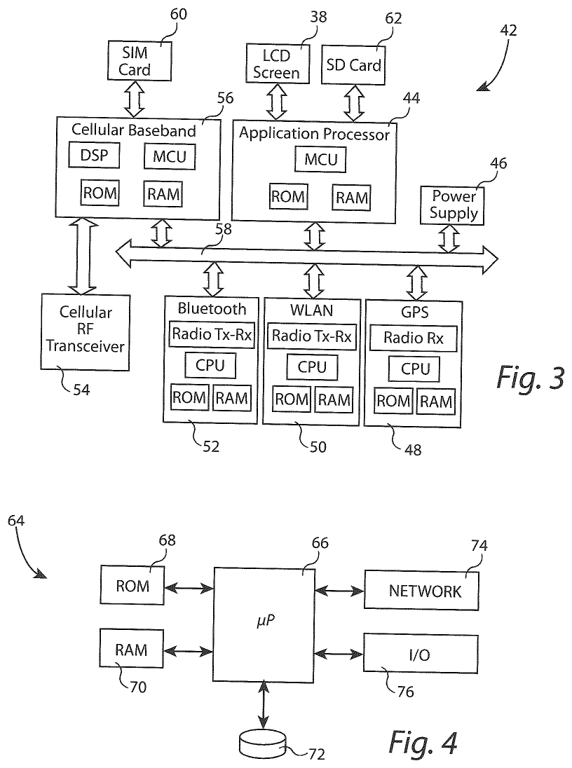

FIG. 3 is a block diagram 42 of the circuitry of an example mobile device and includes an application processor module 44, a power supply 46, a Global Positioning System (GPS) module 48, a wireless LAN (WLAN) module 50, a Bluetooth module 52, a cellular RF transceiver 54, and a cellular baseband module 56. Cellular RF transceiver 54 is coupled to cellular baseband module 56 and application processor module 44, power supply 46, GPS module 48, WLAN module 50, Bluetooth module 52, and a cellular baseband module 56 are coupled to a common bus 58. A subscriber identity module (SIM) card 60 is coupled to the cellular baseband module 56, and a touchscreen 38 and secure digital (SD) card 62 are coupled to application processor 44. Each of the modules include a processor, random access memory (RAM) and read-only memory (ROM) as well as other components for their specific functions. The WLAN 50 and the cellular RF transceiver 54 can serve as network interfaces by wirelessly communicating with, for example, WiFi access point 34 and cellular data tower 32, respectively.

In FIG. 4, an example computer/server 64 includes a microprocessor (μP) 66, read only memory (ROM) 68, random access memory (RAM) 70, mass storage 72, a network interface 74, and input/output (I/O) 76. Computer/server 64 is suitable for use as a personal computer 30 or as a server 14. The mass storage 72 is typically a high-capacity solid state drive.

The Human Readable Data Structure (HRDS) as used herein is used as an interprocess communication for application software development and configuration. That is, the original app 12 downloaded from the app store 28 includes an initial HRDS 16′ that is used to configure the app 12, e.g., the placement and functionality of buttons, widgets, etc. on the GUI 38. When the server 14 automatically develops an updated HRDS 16, it can be downloaded via the internet to replace the initial HRDS 16′, thereby updating and reconfiguring the app 12 without requiring human coding or intervention.

By way of non-limiting example, the HRDS 16/16′ can be a data structure using a limited vocabulary of common English terms. The advantage of such a structure for interprocess communication (e.g., communication between the processes of backend server 14 and mobile device 18) is that it can easily be used among various operating systems. For example, the HRDS 16 can be used with both iOS and Android operating systems. The structure of the HRDS and limited vocabulary make it easy to communicate between processes, and the common English terms facilitate automated generation of updated HRDS by, for example, language parsing algorithms and/or generative AI.

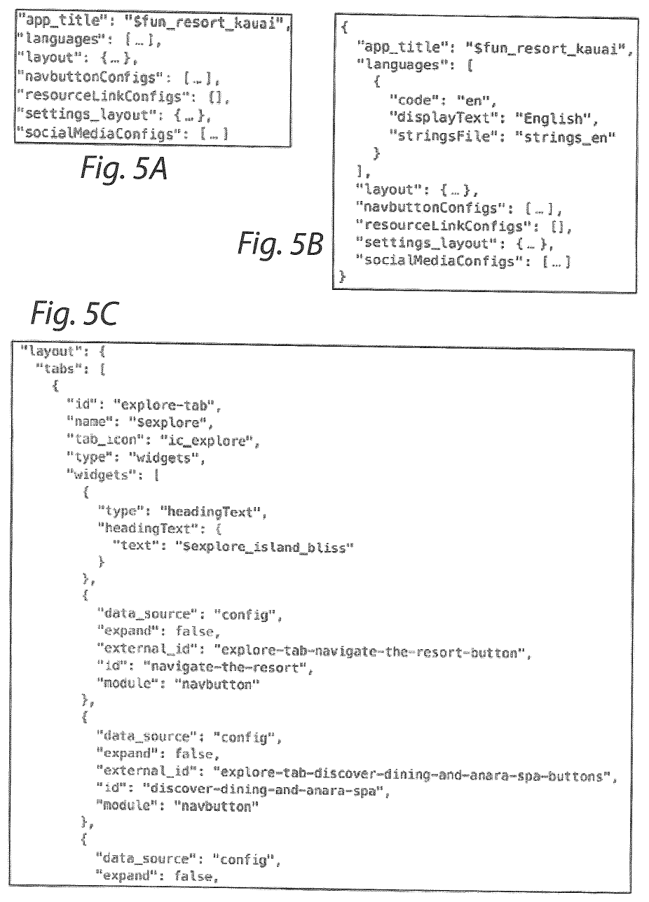

By way of non-limiting example, the HRDS can include six main sections:
1. Languages: Specifies supported languages, using prefixed variables (e.g., $app_title for language-specific labels).
2. Layout: Defines navigation tabs and their components, such as widgets and buttons.
3. NavbuttonConfigs: Details button styles, images, and linking rules.
4. ResourceLinkConfigs: Manages app-wide resource linking.
5. Settings Layout: Customizes the settings screen appearance.
6. SocialMediaConfigs: Configures social media integration.
   An example of a HRDS data structure template is shown in FIG. 5A, an example of the HRDS data structure modified with language parameters is shown in FIG. 5B, and an example of a, HRDS layout modification can be found in FIG. 5C.

The HRDS examples of FIGS. 5A, 5B and 5C are based upon a JavaScript Object Notation (JSON) standard, which is an open standard file format and data interchange format that uses human-readable text to store and transmit data objects including name-value pairs and arrays (or other serializable values). There are many alternatives with trade-off in terms of readability, efficiency, and east of use. By way of non-limiting examples, the HRDS may also be expressed as one or more of the following standards:
1. XML (Extensible Markup Language)—More verbose than JSON but supports attributes, namespaces, and schema validation.
2. YAML (YAML Ain't Markup Language)—Similar to JSON but more human-friendly due to its indentation-based structure.
3. TOML (Tom's Obvious, Minimal Language)—Designed for configuration files; more readable than JSON but less flexible.
4. CSV (Comma-Separated Values)—A simple table-based format where each row is a record, and fields are separated by commas.
5. TSV (Tab-Separated Values)—Similar to CSV but uses tabs instead of commas.
6. MessagePack—A compact binary format similar to JSON but optimized for size and speed.
7. Protobuf (Protocol Buffers)—A schema-based binary format from Google, more efficient than JSON but requires a predefined schema.
8. Avro—A binary format optimized for big data applications, requiring schema definition.
9. BSON (Binary JSON)—A binary format, similar to JSON but with additional data types.
10. INI (Initialization Files)—Simple key-value pair format often used for configuration files.
11. S-expressions (Symbolic Expressions)—A minimal format used in Lisp programming for representing nested structures.
12. CBOR (Concise Binary Object Representation)—A compact binary format designed to be more efficient than JSON.
13. EDN (Extensible Data Notation)—Similar to JSON but with richer data types.

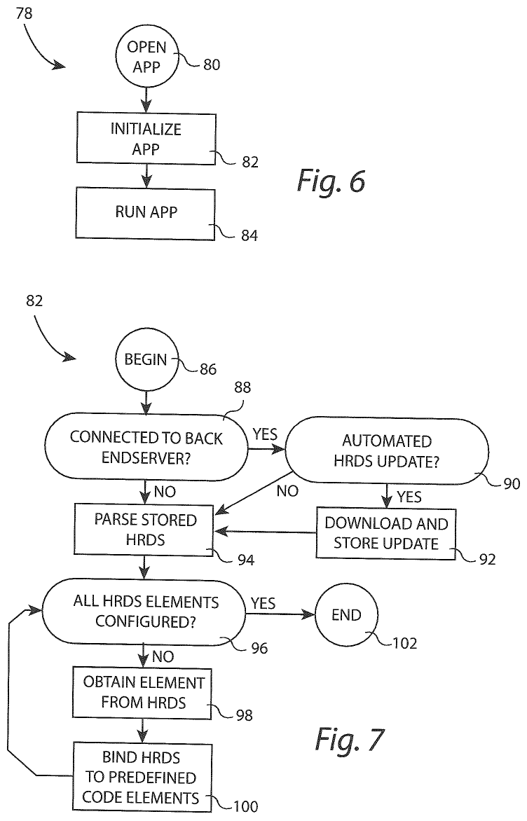

FIG. 6 is a flow diagram of a process 76 to run app 12 on mobile device 18. The app 12 is opened in an operation 80, e.g., by clicking on the app 12 icon on the touchscreen 38 of the mobile device 18. Next, in an operation 82, the app 12 is initialized. Finally, in an operation 84, the configured app 12 is run on the mobile device.

FIG. 7 is a flow diagram illustrating an example initialize app process 82 of FIG. 6. Process 82 begins at 86 and, in an operation 88 it is determined if there is a connection from the app 12 to the back end server 14. If so, the back end server 14 is queried to determine if there is an updated, automatically generated HRDS 16 available. If so, the app 12 downloads the updated HRDS 16 and stores it as HRDS 16′ on the mobile device 18, and process control proceeds to operation 94, wherein the stored HRDS 16′ is parsed. If there is no connection to the back end server in operation 88, or if there is no automated HRDS update in operation 90, process control proceed immediately to operation 94. Next, in an operation 96, it is determined if all HRDS 16′ elements have been configured. If not, the next element from HRDS 16′ is obtained in an operation 98, and the element is bound to a corresponding code element in an operation 100, e.g., a button position, label and functionality. If operation 96 determines that all of the HRDS 16′ elements have been configured, the process 82 ends at 102.

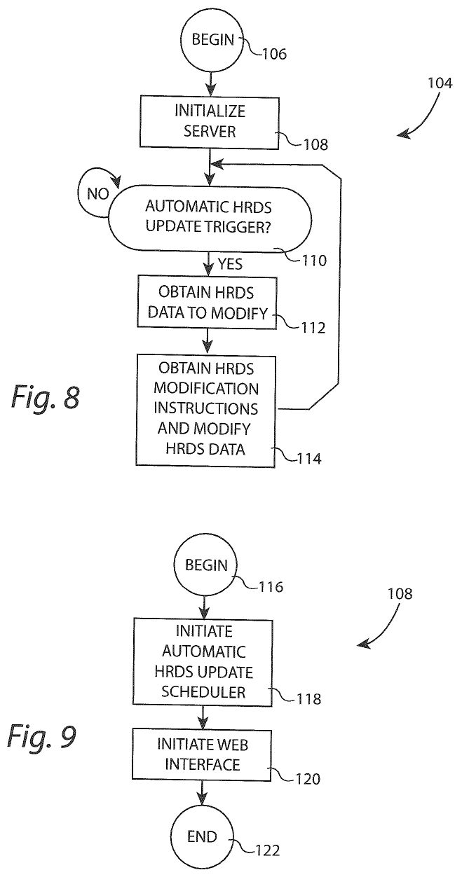

FIG. 8 is a flow diagram of an example process 104 running on back end and web server 14. The process 104 begins at 106 and, in an operation 108, the server 14 is initialized. Next, in an operation 110, it is determined if there is an automatic HRDS update trigger. If not, the process 104 idles at operation 110. If an automatic HRDS update trigger is detected by operation 110, an operation 112 obtains the appropriate HRDS to modify. The HRDS can be the initial version of a HRDS, the current version of the HRDS, other versions of the HRDS, or a null version of a HRDS (e.g., a HRDS data structure template as illustrated in FIG. 5A). In an operation 114, HRDS modification instructs are obtained and the HRDS data is modified in accordance with the instructions. Process control then returns to operation 110 to await the next automatic HRDS update trigger.

FIG. 9 is a flow diagram of an example initial server operation 108. Process 108 begins at 116 and, in an operation 118, an automatic HRDS update scheduler is initiated. Next, in an operation 120, a web interface is initiated. Process 108 then ends at 122. It should be noted that operations 118 and 120 are presented by way of example, and there are other ways to initiate an automatic HRDS update trigger.

There are a number of ways that operation 118 can automatically initiate an automatic HRDS update trigger. For example, an automatic HRDS update trigger can be calendared to be automatically generated on a quarterly basis. As another example, an automatic HRDS update trigger can be scheduled based upon an analysis of the frequency and number of requests for updates by the app.

Operation 120 opens a web interface that is accessible to owners or managers of the app 12 who can request an HRDS update via, for example, a web browser. The requested update can be based upon base instructions stored on server 14 or can be supplemented or replaced by additional instructions provide via the web interface.

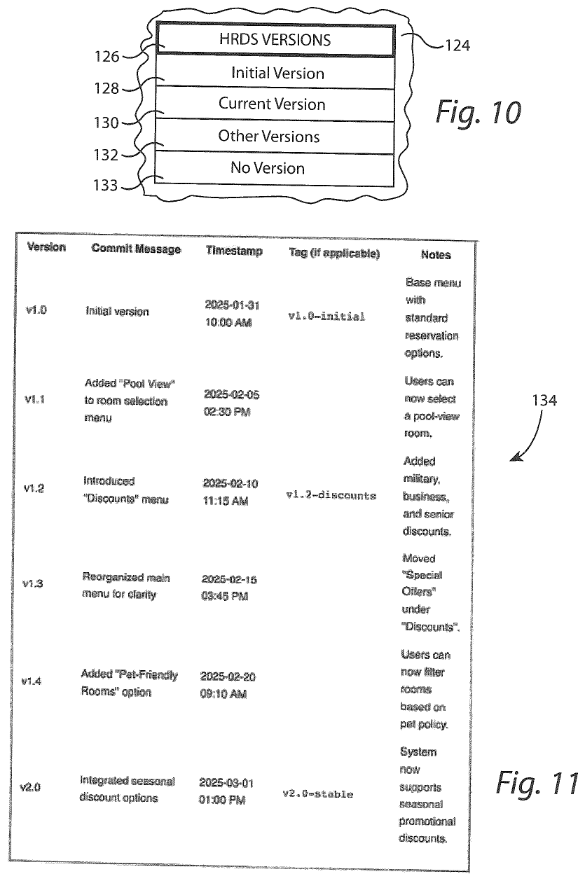

FIGS. 10 and 11 are illustrations of a portion of a web interface 124 displayed, for example, on the screen of computer 30. A part of the web interface 124 is a pull-down menu header 126 for HRDS versions. Under the header 126 are the options “Initial Version” 128, “Current Version” 130, “Other Versions” 132, and “No Version” 133. If the “Other Versions” 132 option is selected, the web interface 124 can provide a HRDS versions table 134 as seen in FIG. 11 to allow selection of the desired version to be modified. This allows the process 112 of FIG. 8 to obtain the desired version of the HRDS to be obtained. If the “No Version” 133 option is selected, a null version of the HRDS can be used, such as the HRDS data structure template of FIG. 5A.

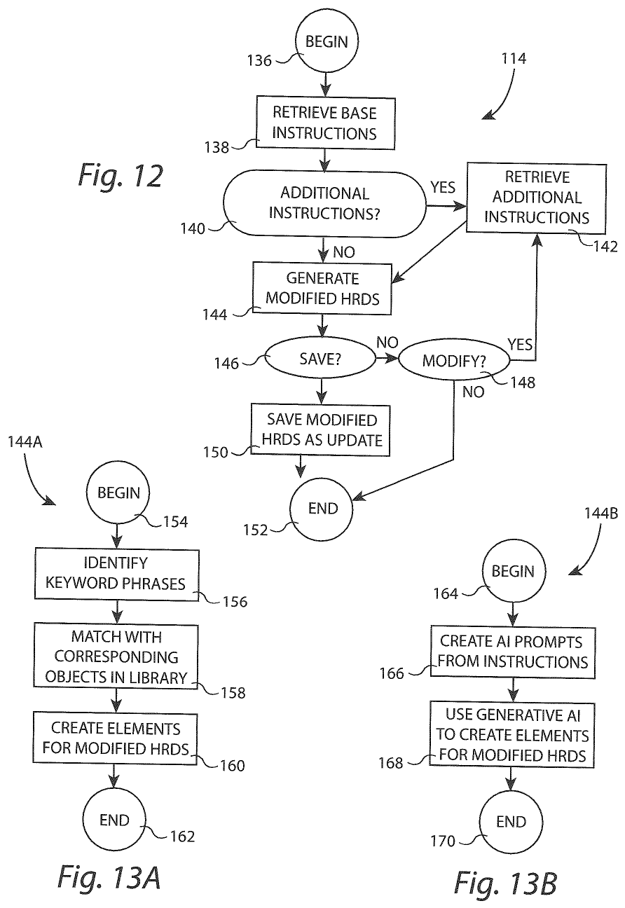

FIG. 12 is a flow diagram of an example operation 114 of FIG. 8 to obtain HRDS modification instructions and to modify HRDS data. In this example, process 114 begins at 136 and, in an operation 138, base instructions are received. These basic instructions can be, for example, examples or rules on how to modify HRDS data. Next, in an operation 140, it is determined if there are additional instructions, e.g., stored on the server 14, obtained via the web interface, etc. If so, an operation 142 retrieves the additional instructions. If there are no additional instructions or after retrieving the additional instructions an operation 144 generates a modified HRDS. Next, in an operation 146 it is determined if the modified HRDS should be saved. This determination can be made using, for example, using analytic or artificial intelligence quality checks in an automated fashion. Alternatively, the modified HRDS can be displayed via the web interface for approval or disapproval. If it is determined that the modified HRDS should not be saved, an operation 148 determines if the modified HRDS should be further modified. If so, the process flow returns to operation 142 for additional instructions. If operation 146 determines that the modified HRDS should be saved it is saved as an updated HRDS on the server 14 and process 114 ends at 152. The process 114 also ends at 152 if operation 146 determines that the modified HRDS should not be saved and operation 148 determines that the modified HRDS decides that there is not to be any further modifications.

FIG. 13A is a flow diagram of an example algorithmic process 144A to automatically generate a modified HRDS. Process 144A begins at 154, and keywords and phrases in the base instructions and/or the additional instructions are identified in an operation 156. These keywords and phrases are matched with corresponding objects in a library stored on server 14 in an operation 158, and elements for the modified HRDS are created. It should be noted that this algorithmic process 144A can be entirely automatic, and do not require human intervention to produce the modified HRDS.

FIG. 13B is a flow diagram of an example generative artificial intelligence (AI) process 144B to automatically generate a modified HRDS. Process 144B begins at 164 and, in an operation 166, AI prompts are created from the base instructions and/or the additional instructions. This prompt creation is facilitated if the instructions are natural language instructions easily understood by the generative AI. Next, in an operation 168, a generative AI process, such as OpenAI, is used to create elements for the modified HRDS using the AI prompts. Process 144B then ends at 170.

It should be noted that the HRDS is well-adapted for generative AI creation and modification in that it is structured and is based upon natural language elements. For example, the base instructions can include a library of reusable components, including various button styles, text labels, navigation tools, and widgets such as news fees, event lists, and social media modules. Other supported components can include directories, maps, digital keys, message inboxes, and settings screens.

Within the context of a given HRDS file (e.g., the six main sections illustrated in FIG. 5A), a simple prompt such as “Create an app for XYZ Resort” can prompt the generative AI to research the resort's offerings, design a layout highlighting key features, generate visuals and content, and develop the corresponding HRDS. The instructions can also request specific styles, such as “relaxion-focused” or “business-oriented” and rapidly receive tailored options for review. This modification/development of the appearance and functionality of the app produces either an update to a previous HRDS version of the app or an entirely new HRDS version when starting from a null version of the HRDS, e.g., the six main sections mentioned above. The AI's speed and flexibility allows for rapid iterations and customized solutions, either entirely automatically or with user input.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part. It is therefore intended that the claims be interpreted in accordance with the true spirit and scope of the invention without limitation or estoppel.

What is claimed is:

1. An interprocess communication system for application software comprising:
an application program (app) including app code segments and a Human Readable Data Structure (HRDS) stored in a memory of a mobile device having a processor and a network interface, the app code segments including,
code segments communicating via the network interface of the mobile device;
code segments downloading an automated HRDS update via the network interface of the mobile device and storing the automated HRDS update in the memory of the mobile device in an interprocess communication;
code segments configuring the app with the automated HRDS update; and
a server including server code segments stored in a server memory, a processor, and a network interface, the server code segments including,
code segments communicating via the network interface of the server;
code segments detecting an automated HRDS update trigger;
code segments obtaining an HRDS to modify; and
code segments modifying the HRDS in accordance with modification instructions to provide the automated HRDS update.

2. An interprocess communication system for application software as recited in claim 1 wherein the mobile device is a smartphone including a touch screen capable of displaying a graphical user interface (GUI), wherein the GUI is configured by the automated HRDS update.

3. An interprocess communication system for application software as recited in claim 2 wherein the smartphone and the server communicate, at least in part, over the internet.

4. An interprocess communication system for application software as recited in claim 3 wherein the code segments downloading an automated HRDS update include:
code segments determining if there is a connection to the server; and
code segments determining if there is an automated HRDS update on the server.

5. An interprocess communication system for application software as recited in claim 4 wherein the code segments configuring the app include:
code segments parsing the stored HRDS for one or more elements; and
code segments binding the HRDS to predetermined code elements.

6. An interprocess communication system for application software as recited in claim 4 wherein server code segments detecting an automatic HRDS update trigger include code segments automatically generating the automatic HRDS update trigger.

7. An interprocess communication system for application software as recited in claim 4 wherein code segments detecting an automatic HRDS update trigger include:
code segments developing a web interface; and
code segments detecting an interaction with the web interface.

8. An interprocess communication system for application software as recited in claim 4 wherein code segments obtaining an HRDS to modify includes choosing one of a current version of the HRDS, a past version of the HRDS, and a null version of the HRDS.

9. An interprocess communication system for application software as recited in claim 8 wherein the past version of the HRDS includes an initial version of the HRDS and wherein the null version of the HRDS is a HRDS data structure template.

10. An interprocess communication system for application software as recited in claim 4 wherein the code segments modifying the HRDS include,
code segments retrieving base instructions;
code segments determining if there are additional instructions;
code segments generating a modified HRDS from the base instructions and the additional instructions, if any.

11. An interprocess communication system for application software as recited in claim 10 wherein the code segments modifying the HRDS further include code segments determining if the modified HRDS should be saved.

12. An interprocess communication system for application software as recited in claim 11 wherein the code segments modifying the HRDS further include,
code segments saving the modified HRDS if it is determined that the modified HRDS is to be saved; and
code segments determining if additional instructions should be received if the modified HRDS is not to be saved.

13. An interprocess communication system for application software as recited in claim 10 wherein at least one of the base instructions and the additional instructions are natural language instructions.

14. An interprocess communication system for application software as recited in claim 13 wherein the natural language instructions are used to generate the modified HRDS using an algorithmic process.

15. An interprocess communication system for application software as recited in claim 14 wherein the natural language instructions are used to generate the modified HRDS using a generative artificial intelligence (AI) process.

16. An interprocess communication system for application software as recited in claim 15 wherein the natural language instructions are AI prompts.

17. A method for interprocess communication for application software comprising:
storing a Human Readable Data Structure (HRDS) on a server;
automatically updating the stored HRDS in accordance with modification instructions; and
transmitting the stored HRDS to a smartphone having a touch screen capable of displaying a graphical user interface (GUI) as an interprocess communication;
wherein the GUI of the smartphone is configured by the HRDS.

18. A method for interprocess communication for application software as recited in claim 17 wherein the modification instructions are natural language instructions.

19. A method for interprocess communication for application software as recited in claim 18 wherein the natural language instructions are used to update the stored HRDS using an algorithmic process.

20. A method for interprocess communication for application software as recited in claim 18 wherein the natural language instructions are used to update the stored HRDS using a generative artificial intelligence (AI) process.
